(19) United States
(12) Patent Application Publication
(10) Pub. No.: US 2005/0039057 A1
(43) Pub. Date: Feb. 17, 2005

(54) Method and apparatus for authenticating a user using query directed passwords

(76) Inventors: Amit Bagga, Green Brook, NJ (US); Jon Bentley, New Providence, NJ (US); Lawrence O'Gorman, Madison, NJ (US)

Correspondence Address: Ryan, Mason & Lewis, LLP, Suite 205, 1300 Post Road, Fairfield, CT, 06824, US

(21) Appl. No.: 10/626,483

(22) Filed: Jul. 24, 2003

(51) Int. Cl. G06F 11/30; G06F 12/14

(52) U.S. Cl. 713/202

(57) ABSTRACT

A query directed password scheme is disclosed that employs attack-resistant questions having answers that generally cannot be correlated with the user using online searching techniques, such as user opinions, trivial facts, or indirect facts. During an enrollment phase, the user is presented with a pool of questions from which the user must select a subset of such questions to answer. Information extraction techniques optionally ensure that the selected questions and answers cannot be correlated with the user. A security weight can optionally be assigned to each selected question. The selected questions should optionally meet predefined criteria for topic distribution. During a verification phase, the user is challenged with a random subset of the questions that the user has previously answered and answers these questions until a level of security for a given application is exceeded as measured by the number of correct questions out of the number of questions asked. Security may be further improved by combining the query directed password protocol with one or more additional factors such as Caller ID that assure that the questions are likely asked only to the registered user.

### CROSS-REFERENCE TO RELATED APPLICATIONS

The present application is related to United States Patent Application entitled “Method and Apparatus for Authenticating a User Using Three Party Question Protocol” (Attorney Docket Number 502079), incorporated by reference herein.

### FIELD OF THE INVENTION

The present invention relates generally to user authentication techniques and more particularly, to methods and apparatus for authenticating a user using a question-response procedure.

### BACKGROUND OF THE INVENTION

A number of security issues arise when computers or other resources are accessible by humans. Most computers and computer networks incorporate computer security techniques, such as access control mechanisms, to prevent unauthorized users from accessing remote resources. Human authentication is the process of verifying the identity of a user in a computer system, often as a prerequisite to allowing access to resources in the system. A number of authentication protocols have been proposed or suggested to prevent the unauthorized access of remote resources. In one variation, each user has a password that is presumably known only to the authorized user and to the authenticating host. Before accessing the remote resource, the user must provide the appropriate password, to prove his or her authority.

A simple password mechanism, however, often does not provide sufficient security for a given application, since many users select a password that is easy to remember and therefore easy for an attacker to guess. In order to improve the security of passwords, the number of login attempts is often limited (to prevent an attacker from guessing a password) and users are often required to change their password periodically. Some systems use simple methods such as minimum password length and prohibition of dictionary words to evaluate a user selected password at the time the password is selected, to ensure that the password is not particularly susceptible to being guessed. In addition, many systems encrypt a password before it is transmitted from a user's terminal, to ensure that the password cannot be read when it is transmitted.

One-time, challenge-response passwords have been proposed as a mechanism for further increasing security. Generally, users are assigned a secret key, presumably known only to the user and the remote resource. The secret key may be stored, for example, on a pocket token or a computer-readable card. Upon attempting to access a desired remote resource, a random value, known as a “challenge,” is issued to the user. The user then generates an appropriate “response” to the challenge by encrypting the received challenge with the user's secret key (read from the pocket token or computer-readable card), using a known encryption algorithm, such as the data encryption standard (DES). The user transmits the calculated response to the desired remote resource, and obtains access to the requested resource if the response is accurate. In order to ensure that the pocket token or computer-readable card is being utilized by the associated authorized user, the security may be supplemented by requiring the user to enter a memorized PIN (personal identification number) or password.

In a call center environment, users are often authenticated using traditional query directed authentication techniques by asking them personal questions, such as their social security number, date of birth or mother's maiden name. The query can be thought of as a hint to “pull” a fact from a user's long term memory. As such, the answer need not be memorized. Although convenient, traditional authentication protocols based on queries are not particularly secure. For example, most authentication systems employing this approach use a limited number of questions that are static and factual. Thus, the answers can generally be anticipated and easily learned by a potential attacker. Furthermore, the information is generally relayed by the user “in the open;” i.e., an attacker overhearing the call or looking over the shoulder of a user entering the information into a web browser can learn the personal information and thereafter obtain unauthorized access. A need therefore exists for an authentication technique that provides the convenience and familiarity of traditional query directed authentication with greater security.

### SUMMARY OF THE INVENTION

Generally, a method and apparatus are provided for authenticating a user using query directed passwords (QDP). The present invention improves upon traditional query directed authentication methods to provide an authentication scheme with increased security. The disclosed query directed password scheme employs attack-resistant questions having answers that generally cannot be correlated with the user using online searching techniques. For example, questions directed to user opinions, trivial facts, or indirect facts are not widely known and thus are difficult to learn or verify (and thus cannot be easily obtained by an attacker).

During an enrollment phase, the user is presented with a pool of questions from which the user must select a subset of such questions to answer. Information extraction techniques are optionally employed during the enrollment phase to ensure that the answers to the user selected questions cannot be qualitatively or quantitatively correlated with the user by a potential attacker. A security weight can optionally be assigned to each selected question. A given question can be discarded if the question is compromised since users are presented with a larger pool of potential questions. In addition, the larger pool of potential questions allows the user to bypass a particular question that he or she does not want to answer (for example, due to privacy concerns). A further feature of the invention ensures that the questions selected by the user to answer from the larger pool of questions meet predefined criteria for topic distribution. Users should generally select questions for which the user will provide consistent answers.

During a verification phase, when the user attempts to access a protected resource, the user is challenged with a random subset of the questions that the user has previously answered. The user answers questions until a level of security for a given application is exceeded, for example, based on a sum of security weights of correctly answered questions. The random selection of questions for a verification session defends against a replay attack such that an attacker cannot repeat a single session's authentication response verbatim between different sessions. The security of the authentication scheme of the present invention may be further improved by combining the query directed password protocol with one or more additional factors to which the questions are sent to the user, such as the required possession of a communication device, such as a given cellular telephone or personal digital assistant, a codebook, or a personal identification number (PIN).

A more complete understanding of the present invention, as well as further features and advantages of the present invention, will be obtained by reference to the following detailed description and drawings.

### BRIEF DESCRIPTION OF THE DRAWINGS

FIG. 1 illustrates a network environment in which the present invention can operate;

FIG. 2 is a schematic block diagram illustrating the query directed password server of FIG. 1 in further detail;

FIG. 3 is a sample table from an exemplary question database of FIGS. 1 and 2;

FIG. 4 is a sample table from an exemplary user database of FIGS. 1 and 2;

FIG. 5 is a flow chart describing an exemplary implementation of an enrollment process of FIG. 2 incorporating features of the present invention; and

FIG. 6 is a flow chart describing an exemplary implementation of a verification process of FIG. 2 incorporating features of the present invention.

### DETAILED DESCRIPTION

The present invention recognizes that authentication schemes based on queries with known—not memorized—answers are convenient and familiar. According to one aspect of the present invention, improvements are made upon traditional query directed authentication methods to provide an authentication scheme with increased security. The disclosed authentication scheme is based on a more rigorous infrastructure in which security is specifiable and measurable. An authentication scheme in accordance with the present invention employs attack-resistant questions whose answers are trivial facts, indirect facts, or opinions that are not widely known and thus are difficult to learn or verify. In this manner, the answers to the questions cannot be easily obtained by an attacker. We call this new scheme query directed passwords, or QDP.

As used herein, attack-resistant questions are questions whose answers generally cannot be correlated with the user who selects these questions and answers using online searching techniques, such as user opinions, trivial facts, or indirect facts. Generally, answers to such attack-resistant questions should be difficult for a potential attacker to learn. In addition, while attack-resistant questions, such as user opinions and habits, should be obscure, they need not be a “secret.” For example, a user may be asked an opinion such as his or her favorite car, or a trivial fact question such as where the user normally keeps his or her keys.

As used herein, an indirect fact is a fact with at least one level of indirection. In other words, an indirect question asks the user something that he or she knows but, due to the indirection, has no obvious connection to the user. For example, a user may recall the telephone number of a childhood friend, Jim Brown. If the user was merely asked the telephone number of Jim Brown, this answer might easily be obtained by an attacker. The same question can be asked with greater security by indirectly asking the user the telephone number of his or her “childhood friend” or “Fido's telephone number” (assuming Jim Brown had a dog named Fido).

The questions can be open questions, multiple choice questions or a combination of the foregoing. Open questions contain only the question and the user is free to respond to any answer he or she chooses. Multiple choice questions contain a number of answer choices from which the user is free to choose one of those and no other. Questions that combine features of both open and multiple choice questions contain a number of multiple choice answers and another choice that is blank. If the user chooses this choice, then he or she must fill in the appropriate answer.

According to another aspect of the invention, the user is presented during an enrollment phase with a pool of Q questions from which the user must select a subset of N such questions that the user will answer. A security weight can optionally be assigned to each of the N selected questions to estimate the level of difficulty an attacker would have to answer the question correctly. Since users are presented with a larger pool, Q, of potential questions, a given question can easily be discarded if the question is compromised. That is, if it becomes evident that one or more of the N selected questions may be widely known or known by an attacker, then this is compromised and should be eliminated from the user's questions and the user select replacement(s). In addition, since the user is selecting desired questions to answer, the user can bypass a particular question if the user does not want to reveal the answer (e.g., due to privacy concerns). As discussed hereinafter, a further feature of the invention ensures that the questions selected by the user to answer from the larger pool of questions meet predefined criteria for topic distribution. For example, a user may be required to select 15 questions in at least three categories, with no more than seven questions selected from a single category. Users should generally select questions for which the user will provide consistent answers, such as questions that the user has strong opinions or long-term factual knowledge about.

The enrollment questions of a user may be stored by the host or by the user. In the preferred embodiment, these questions should be secured from viewing by anyone else but the true user and the authenticating system. One way to do this is to store an encrypted file on the user's machine. Off-line storage is more secure than on-line storage, so storage of these questions on a smart card or on a wallet card that is kept securely in a wallet, purse, or file cabinet, are all examples of good storage locations of the questions. Even if the questions are found, such as, for example, by stealing the wallet in which a wallet card containing the questions was located, an attacker would not know the answers to the questions, so obtaining the questions does not reveal the answers needed to prove authentication.

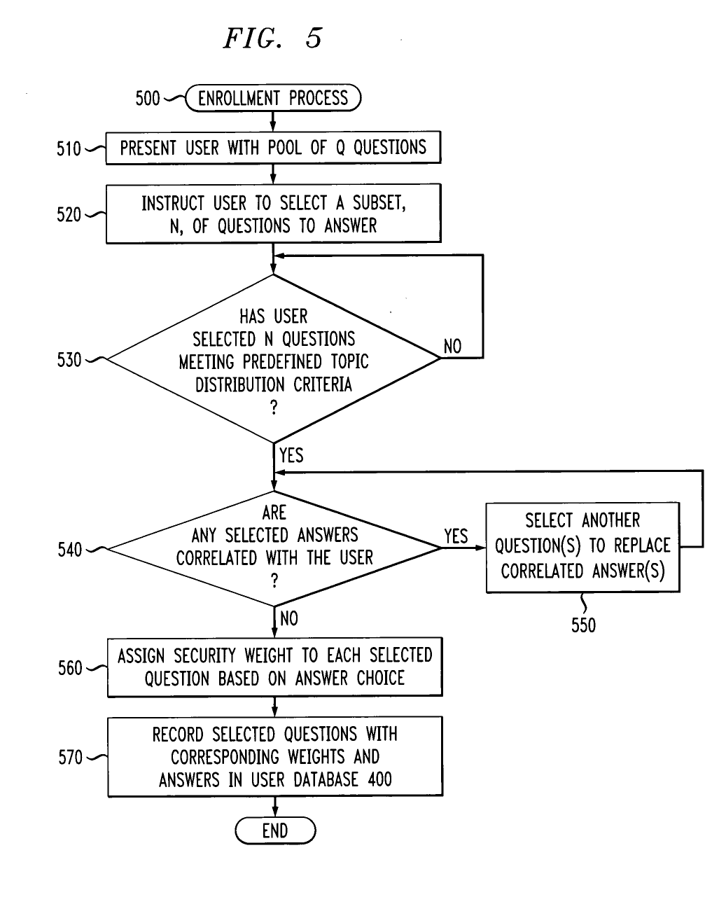

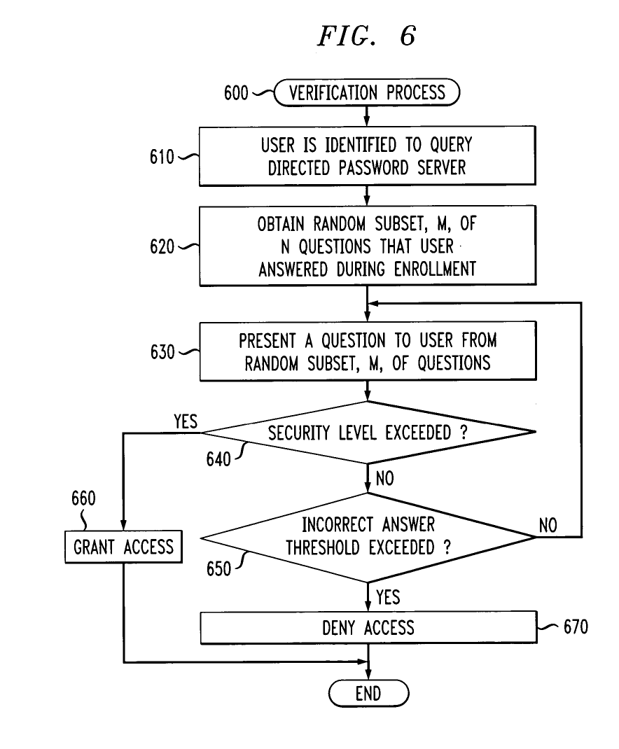

The authentication scheme in accordance with the present invention optionally also employs information extraction techniques during the enrollment phase to ensure that the answers to the user selected questions cannot be qualitatively or quantitatively correlated with the identity of the user by a potential attacker. Generally, the information extraction techniques ensure that a given answer cannot be correlated with a given user by performing an online or curriculum vitae search of any correlated material between the user and the answer. For example, if a user selects a telephone number of a person, the information extraction techniques determine if there is a predefined relationship between the owner of the telephone number and the user, such as a family member (self, sibling or parent), co-author, colleague or member of the same household. If so, this telephone number is said to be correlated with the user and is disallowed as an answer. As another example, if a user selects the jersey number of a sports figure and the information extraction techniques reveal that the user is a fan of the sports team on which the sports figure stars, then that selection would be disallowed. This correlation may be quantitatively weighted, such that if only one correlation is found, the answer may still be allowed, however if many correlations are found, then the answer is disallowed. Such correlation information may be implemented as one or more correlation rules that are evaluated during the enrollment phase, as discussed further below in conjunction with FIG. 5.

During a verification phase, when the user attempts to access a resource that is protected using the present invention, the user is challenged with a random subset, M, of the N questions that the user has previously answered. The user answers questions until a level of security for a given application is exceeded, for example, based on a sum of security weights of correctly answered questions. The actual number, M<=N, of questions answered by the user during a verification phase, may be varied to meet various levels of required security. The M questions randomly chosen for a verification session from the N selected by the user changes from session to session to defend against a replay attack such that an attacker cannot repeat a single session's authentication response verbatim between different sessions. In a further variation, an authentication threshold is employed, whereby the user is granted access to a requested resource once a number of questions are answered correctly above a predefined authentication threshold, even if some questions are answered incorrectly. The predefined authentication threshold is selected based on the security required of a particular application. In a further variation, a combination of question types may be asked. For instance, one open question may be asked combined with three multiple choice questions, where the latter are chosen randomly from the N selected by the user.

It is noted that four QDP multiple choice questions (each with six answers) provide a keyspace of (6)⁴ or 1296. Although a successful brute force attack is unlikely if the number- of failed authentication attempts is limited to a small number such as 3-5, it is conceivable that an attacker could endeavor to learn answers to the four questions. Thus, the security of the authentication scheme of the present invention may be further improved by combining the query directed password protocol with one or more additional factors. By employing the query directed password protocol with another factor in a two-factor authentication model, the present invention offers strong security from weak factors. For example, if a four-question query directed password protocol is combined with a four-digit randomly selected personal identification number (PIN) (having a keyspace of 10⁴), the combined keyspace becomes 1.3×10⁷. In a variation of this, the user may be asked one open question followed by four multiple choice questions. The open question might have a numerical PIN, but be of QDP type. For instance, “What was the last 4 digits of my telephone number as a child?” yields a 4-digit answer like a PIN, but it is of QDP-type because it entails a query of an indirect question. In further variations, the second factor may be the required possession of a communication device, such as a given cellular telephone or personal digital assistant (i.e., “what you have”) whose unique identification is pre-registered with the authenticating host and that the user must employ to receive the questions and provide the answers (i.e., “what you know”).

As another example of a second factor, a codebook can be used in combination with the query directed password protocol to increase security. A codebook contains the questions selected by a given user and the corresponding possible multiple choice answers. The codebook may be embodied in paper or electronic form. The user has the “key” to the codebook, which is knowledge of the answers to the selected questions. In other words, the codebook itself is a form of “what you have” and the answers are a form of “what you know” authentication. Thus, if the codebook is lost, the answers are not evident (in a similar manner to losing a secure token, without losing the PIN). If the codebook is lost, the user will eventually recognize that the codebook is lost and cancel the current questions. Following an enrollment process, a given user, James Smith, can be presented with a wallet card containing the user's N questions and multiple choice answers. Thereafter, during a verification process, the user is challenged with only the question identifiers (numbers) of the subset, M, of questions to be used for verification. The user uses the question identifiers as an index into the wallet card to identify the questions that should be answered for the corresponding question text. The user determines the appropriate answers to the requested questions and returns only the multiple choice identifier of the correct answers. Thus, if someone overhears the question numbers included in the challenge or the multiple choice answers included in the response, they will not obtain the text of the question or the text of the answer, respectively.

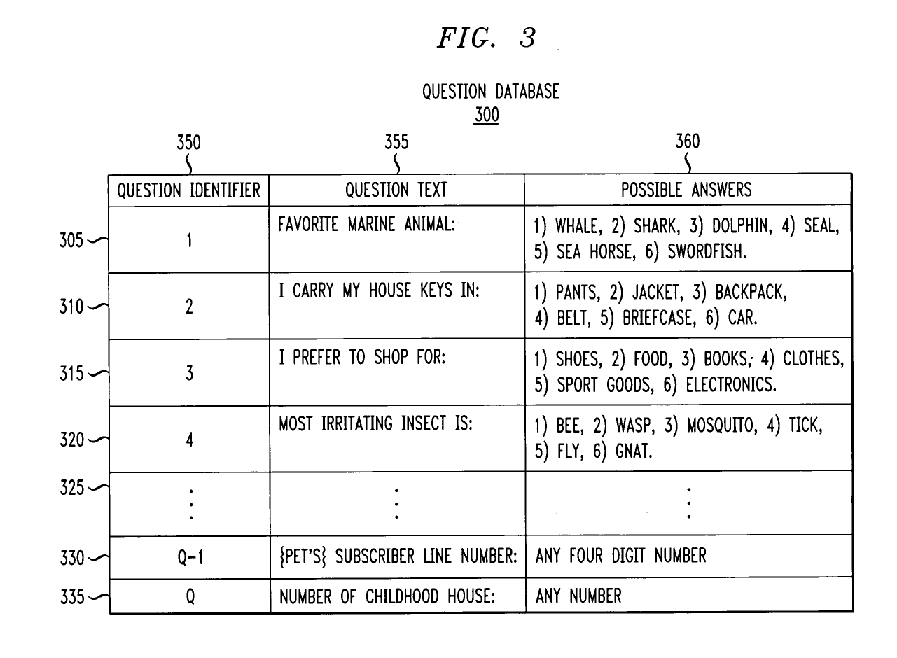

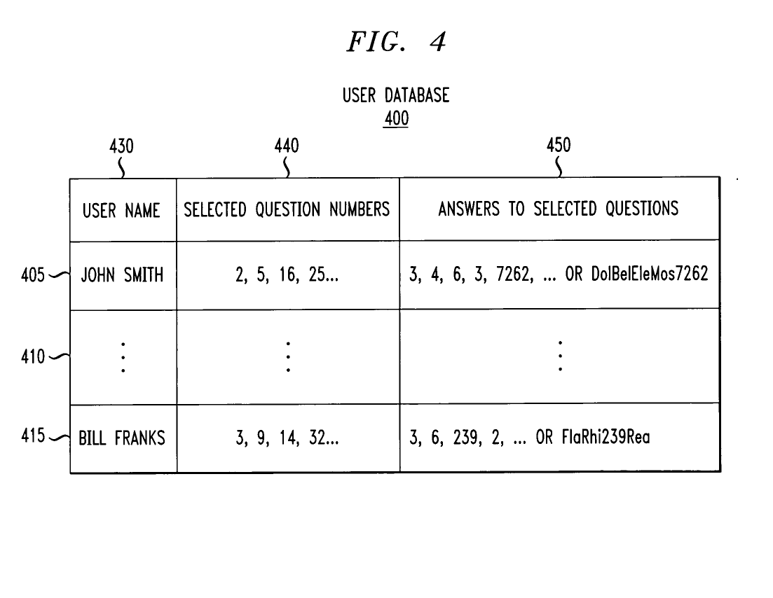

In the verification stage, there are two schemes by which a user can respond to the questions. In one scheme, the user responds to each individual question with an individual answer. For example, for the questions shown in FIG. 3, the user may respond to questions 1 by “dolphin” or “3.” She may respond to question 2 by “belt” or “4.” She may respond to question 3 by “electronics” or “6.” And she may respond to question 4 by “mosquito” or “3.” In another scheme, the user responds to all questions at one time by concatenating answers or portions of answers together. For example, for the questions shown in FIG. 3 and for the same answers given in this paragraph, the user may concatenate the first 3 letters of each answer together to obtain the single response to the 3 questions, “DolBelEleMos” or “3463.” Also illustrated in these examples are two ways to respond to a multiple-choice question. One way is to respond by the word or number that is the multiple-choice answer, for example “dolphin.” The other way is to respond with the index of the multiple-choice answer, for example “3.” It is noted that a concatenation of the index of the multiple-choice answers can be received, for example, by means of a voice response or keypad entry.

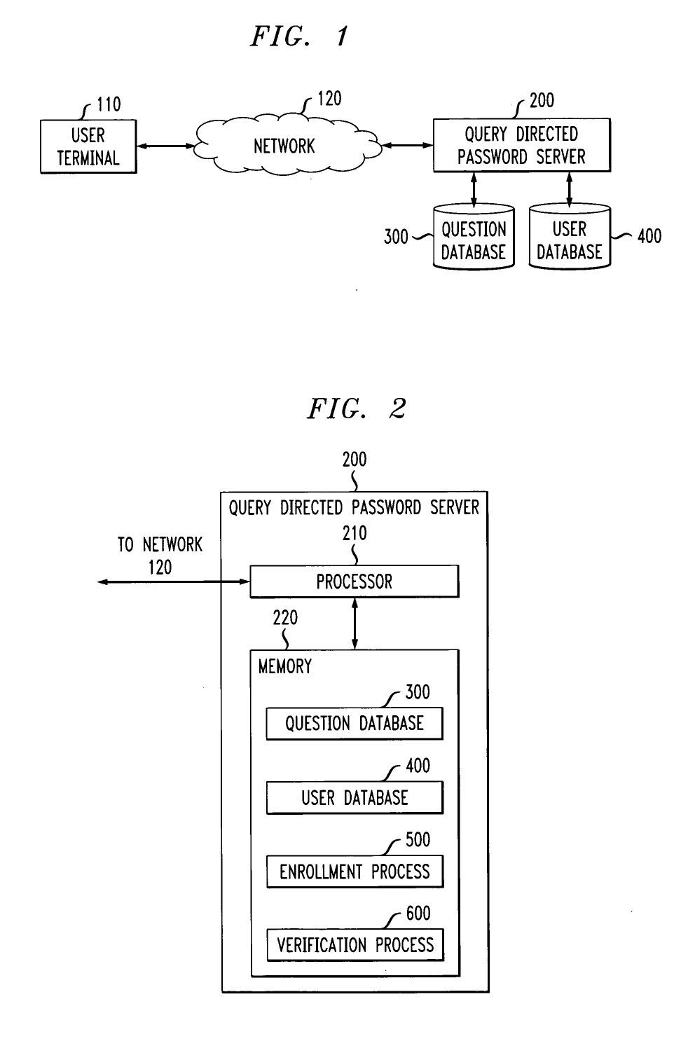

FIG. 1 illustrates the network environment in which the present invention can operate. As shown in FIG. 1, a user employing a user device 110 sends a message over a network 120 to a query directed password server 200, discussed further below in conjunction with FIG. 2. The query directed password server 200 may be associated, for example, with a call center or web server. The network(s) 120 may be any combination of wired or wireless networks, such as the Internet and the Public Switched Telephone Network (PSTN).

As previously indicated, the user is presented during an enrollment phase with a pool of Q questions from a question database 300, discussed further below in conjunction with FIG. 3, from which the user must select and answer a subset, N, of such questions. In addition, during a verification phase, when the user attempts to access a resource that is protected using the present invention, the query directed password server 200 challenges the user with a random subset, M, of the N questions that the user has previously answered, as recorded in a user database 400, discussed further below in conjunction with FIG. 4.

FIG. 2 is a schematic block diagram of an exemplary query directed password server 200 incorporating features of the present invention. The query directed password server 200 may be any computing device, such as a personal computer, work station or server. As shown in FIG. 2, the exemplary query directed password server 200 includes a processor 210 and a memory 220, in addition to other conventional elements (not shown). The processor 210 operates in conjunction with the memory 220 to execute one or more software programs. Such programs may be stored in memory 220 or another storage device accessible to the query directed password server 200 and executed by the processor 210 in a conventional manner.

For example, as discussed below in conjunction with FIGS. 3 through 6, the memory 220 may store a question database 300, a user database 400, an enrollment process 500 and a verification process 600. Generally, the question database 300 records the pool of Q questions from which the user must select a subset, N, of such questions that the user will answer. The enrollment process 500 presents the user with the pool of Q questions from which the user must select a subset of N such questions that the user will answer and ensures that the selected questions meet any predefined criteria for topic distribution and that the associated answers are not correlated with the user. The verification process 600 employs a query directed password protocol incorporating features of the present invention to authenticate a user.

FIG. 3 is a sample table from an exemplary question database of FIGS. 1 and 2. As previously indicated, the question database 300 contains the pool of Q questions that the query directed password server 200 presents to the user for selection of a subset, N, of such questions that the user will answer. Generally, the questions should be selected from a broad range of topics and be designed to be answered consistently. As shown in FIG. 3, the question database 300 consists of a plurality of records, such as records 305-335, each associated with a different question. For each question, the question database 300 records a question identifier, question text and permitted answers, in fields 350, 355 and 360, respectively. For example, question number 1, in record 305, queries the user for a favorite marine animal (an opinion) and presents the user with six possible multiple choice answers. Similarly, question number (Q-1) queries the user for a 4-digit portion of a telephone number associated with a particular pet (which question was chosen and answered by the user during the enrollment phase) and accepts a four digit numerical value to check against the correct answer.

FIG. 4 is a sample table from an exemplary user database of FIGS. 1 and 2. The user database 400 records the subset, N, of questions and answers selected by the user in the enrollment process 500. As shown in FIG. 4, the user database 400 consists of a plurality of records, such as records 405-415, each associated with a different enrolled user. For each enrolled user, the user database 400 identifies the user in field 430, and the selected question numbers in field 440 with the corresponding answers in field 450. In addition, as previously indicated, a security weight can optionally be assigned to each of the N selected questions to estimate the level of difficulty an attacker would have to answer the question correctly.

For example, a user John Miller can be presented with the following M questions and possible answers from the N selected questions:
Favorite marine animal: 1) whale, 2) shark, 3) dolphin, 4) seal, 5) sea horse, 6) swordfish.
I carry my house keys in: 1) pants, 2) jacket, 3) backpack, 4) belt, 5) briefcase 6) car.
I prefer to shop for: 1) shoes, 2) food, 3) books, 4) clothes, 5) sport goods, 6) electronics.
Most irritating insect is: 1) bee, 2) wasp, 3) mosquito, 4) tick, 5) fly, 6) gnat.
Fido's subscriber line number: 7262
   If the answers are provided individually, then the response would be expressed either as the actual answers, “dolphin belt electronics mosquito 7262”, or as the identifiers of multiple choice answers and the actual answers to open questions, “3 4 6 3 7262”. If the answers are provided as a concatenation of the identifier of the correct answer, the authentication response might be expressed as, “34637262”. If the answers are provided as a concatenation of the first letters of multiple-choice questions and the complete answers of open questions, then if 3 first letters is chosen, the answer is expressed as, “DolBelEleMos7262”.

Similarly, a user Frank Flynn can be presented with the following M questions and possible answers from the N selected questions:
The pants fabric I prefer is: 1) khaki, 2) denim, 3) flannel, 4) linen, 5) tweed, 6) synthetic.
Favorite jungle animal: 1) tiger, 2) zebra, 3) elephant, 4) lion, 5) giraffe, 6) rhinoceros.
Childhood house number:______.
What do you prefer to do in your leisure time: 1) shop, 2) read, 4) play sports, 5) be outdoors, 6) garden.
   If the answers are provided individually, then the response would be expressed either as the actual answers, “flannel rhinoceros 239 read”, or as the identifiers of multiple choice answers and the actual answers to open questions, “3 6 239 2”. If the answers are provided as a concatenation of the identifier of the correct answer, the authentication response might be expressed as, “362392”. If the answers are provided as a concatenation of the first letters of multiple-choice questions and the complete answers of open questions, then if 3 first letters is chosen, the answer is expressed as, “FlaRhi239Rea”.

FIG. 5 is a flow chart describing an exemplary implementation of an enrollment process 500 of FIG. 2 incorporating features of the present invention. As previously indicated, the exemplary enrollment process 506 presents the user with the pool of Q questions from which the user must select a subset of N such questions that the user will answer and ensures that the selected questions meet predefined criteria for topic distribution and that the associated answers cannot be correlated with the user.

As shown in FIG. 5, a user is initially presented with the pool of Q questions during step 510. As previously indicated, the pool of Q questions should be selected from a broad range of topics. The user is instructed during step 520 to select a subset of N questions that the user will answer. For example, a user may be required to select 15 questions in at least three categories, with no more than seven questions selected from a single category. Again, users should generally select questions for which the user will provide consistent answers, such as questions that the user has strong opinions about.

A test is performed during step 530 to determine if the user has selected N questions meeting the predefined topic distribution criteria. If it is determined during step 530 that the user has not yet selected N questions meeting the predefined topic distribution criteria, then program control returns to step 530. If, however, it is determined during step 530 that the user has selected N questions meeting the predefined topic distribution criteria, then a further test is performed during step 540 to determine if any of the selected answers can be correlated with the user. In one implementation, one or more correlation rules may be defined to ensure that a given answer is not correlated with the user. For example, if a user selects a telephone number of a person, the information extraction analysis performed during step 540 determine if there is a predefined relationship between the owner of the telephone number and the user, such as a family member (self, sibling or parent), co-author, colleague or member of the same household (qualitative correlation rule).

For example, if a user selects a telephone number of a person, the information extraction analysis performed during step 540 determines if there is a predefined relationship between the owner of the telephone number and the user, such as a family member (self, sibling or parent), co-author, colleague or member of the same household. The analysis correlates the number to the person by analyzing the number of hits obtained by using a search engine (such as Google) where both the person and number appear on the same page. If the number of hits is higher than a chosen threshold, then a positive correlation is said to exist. Alternatively, the information extraction analysis may also use specialized web databases such as www.anywho.com that allow retrieval of information associated with a particular telephone number. The metric in this case is a positive match between the user's answer and the match against the phone entry.

If it is determined during step 540 that at least one answer can be correlated with the user, then these answers are discarded and the user is requested to select additional questions during step 550. If, however, it is determined during step 540 that the answers cannot be correlated with the user, then a weight is assigned to each selected question during step 560 to estimate the level of difficulty an attacker would have to answer the question correctly. Generally, the weights are inversely related to the probability of an answer being chosen by a wide population of users. For instance, consider a question, “what food do you like best of these choices: 1) steak, 2) liver, 3) ice cream, 4) corn, 5) chicken, 6) rutabaga. Let us say that in a sampling of the population, people chose these answers in the following respective proportions: 1) 30%, 2) 3%, 3) 40%, 4) 10%, 5) 15%, 6) 2%. Because ice cream and steak could be guessed by an attacker as more likely than liver and rutabaga to be the answer of a user, the system gives less weight to these more popular answers. One way to weight these answers is by the inverse of the probability, so the weights here would be: 1) 3.33, 2) 33.3, 3) 2.5, 4) 10, 5) 6.6, 6) 50.

The selected questions, and corresponding weights and answers are recorded in the user database 400 during step 570 before program control terminates.

FIG. 6 is a flow chart describing an exemplary implementation of the verification process 600 of FIG. 2 incorporating features of the present invention. As previously indicated, the verification process 600 employs a query directed password protocol incorporating features of the present invention to authenticate a user.

As shown in FIG. 6, the user initially identifies himself (or herself) to the query directed password server 200 during step 610. During step 620, the verification process 600 obtains a random subset of M questions from the N questions in the user database 400 that the user answered during the enrollment phase. The random subset of M questions are presented to the user during step 630 until a level of security for the application is exceeded during step 640 (to grant access during step 660) based on the sum of security weights of correctly answered questions, or until a predefined threshold is exceeded during step 650 for incorrect answers (to deny access during step 670).

As is known in the art, the methods and apparatus discussed herein may be distributed as an article of manufacture that itself comprises a computer readable medium having computer readable code means embodied thereon. The computer readable program code means is operable, in conjunction with a computer system, to carry out all or some of the steps to perform the methods or create the apparatuses discussed herein. The computer readable medium may be a recordable medium (e.g., floppy disks, hard drives, compact disks, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used. The computer-readable code means is any mechanism for allowing a computer to read instructions and data, such as magnetic variations on a magnetic media or height variations on the surface of a compact disk.

The computer systems and servers described herein each contain a memory that will configure associated processors to implement the methods, steps, and functions disclosed herein. The memories could be distributed or local and the processors could be distributed or singular. The memories could be implemented as an electrical, magnetic or optical memory, or any combination of these or other types of storage devices. Moreover, the term “memory” should be construed broadly enough to encompass any information able to be read from or written to an address in the addressable space accessed by an associated processor. With this definition, information on a network is still within a memory because the associated processor can retrieve the information from the network.

It is to be understood that the embodiments and variations shown and described herein are merely illustrative of the principles of this invention and that various modifications may be implemented by those skilled in the art without departing from the scope and spirit of the invention.

1. A method for authenticating a user, comprising:
obtaining an asserted identity of said user;
obtaining a random subset of questions that said user has previously answered, wherein a correlation between said user and said previously answered questions does not violate one or more predefined correlation rules; and
presenting one or more questions to said user from said random subset of questions until a predefined security threshold is satisfied.

2. The method of claim 1, wherein said predefined security threshold is based on a sum of security weights of correctly answered questions.

3. The method of claim 1, wherein one or more of said questions are directed to an opinion of said user.

4. The method of claim 1, wherein one or more of said questions are directed to a trivial fact.

5. The method of claim 1, wherein one or more of said questions are directed to an indirect fact.

6. The method of claim 1, further comprising the step of presenting said user with a larger pool of potential questions for selection of one or more questions to answer.

7. The method of claim 6, further comprising the step of ensuring that said questions selected by said user meet predefined criteria for topic distribution.

8. The method of claim 6, wherein said larger pool of potential questions are selected to be attack resistant.

9. The method of claim 1, wherein said one or more predefined correlation rules ensure that answers to user selected questions cannot be qualitatively correlated with said user.

10. The method of claim 1, wherein said one or more predefined correlation rules ensure that answers to user selected questions cannot be quantitatively correlated with said user.

11. The method of claim 1, further comprising the step of requiring said user to have a second factor.

12. The method of claim 11, wherein said second factor is a required possession of a given device.

13. The method of claim 11, wherein said second factor is a required personal identification number.

14. The method of claim 11, wherein said second factor is a computer file, wallet card, or piece of paper on which is written the user's selected questions and corresponding question indices.

15. The method of claim 11, wherein said second factor is a computer file, wallet card, or piece of paper on which is written the user's selected questions and corresponding question indices.

16. The method of claim 1, wherein said questions from said random subset of questions are presented to said user in a random order.

17. The method of claim 1, wherein said questions are presented to said user in the form of an index identifying each question.

18. The method of claim 1, wherein answers to said questions are received from said user in the form of an index identifying each answer.

19. The method of claim 16, wherein said index identifying each answer can be aggregated to form a password.

20. The method of claim 16, wherein a portion of each answer can be aggregated to form a password.

21. The method of claim 1, further comprising the step of storing an indication of said subset of questions on a device or a wallet card or a piece of paper associated with said user.

22. An apparatus for authenticating a user, comprising:
a memory; and
at least one processor, coupled to the memory, operative to:
obtain an asserted identity of said user;
obtain a random subset of questions that said user has previously answered, wherein a correlation between said user and said previously answered questions does not violate one or more predefined correlation rules; and
present one or more questions to said user from said random subset of questions until a predefined security threshold is satisfied.

23. The apparatus of claim 20, wherein said predefined security threshold is based on a sum of security weights of correctly answered questions.

24. The apparatus of claim 20, wherein one or more of said questions are directed to an opinion of said user.

25. The apparatus of claim 20, wherein one or more of said questions are directed to a trivial fact.

26. The apparatus of claim 20, wherein one or more of said questions are directed to an indirect fact.

27. The apparatus of claim 20, wherein said processor is further configured to ensure that questions selected by said user meet predefined criteria for topic distribution.

28. The apparatus of claim 20, wherein said one or more predefined correlation rules ensure that answers to user selected questions cannot be qualitatively correlated with said user.

29. The apparatus of claim 20, wherein said one or more predefined correlation rules ensure that answers to user selected questions cannot be quantitatively correlated with said user.

30. The apparatus of claim 20, wherein said questions from said random subset of questions are presented to said user in a random order.

31. The apparatus of claim 20, wherein said processor is further configured to store an indication of said subset of questions on a device associated with said user.

32. An article of manufacture for authenticating a user, comprising a machine readable medium containing one or more programs which when executed implement the steps of:
obtaining an asserted identity of said user;
obtaining a random subset of questions that said user has previously answered, wherein a correlation between said user and said previously answered questions does not violate one or more predefined correlation rules; and
presenting one or more questions to said user from said random subset of questions until a predefined security threshold is satisfied.
